(19) United States
(12) Patent Application Publication
(10) Pub. No.: US 2021/0160001 A1
(43) Pub. Date: May 27, 2021

(54) TAMPERING DETECTION IN PHASE BASED RANGING

(71) Applicant: QUALCOMM Incorporated, San Diego, CA (US)

(72) Inventors: Paul Dominic HISCOCK, Cambridge (GB); Thomas ALLAN, St Neots (GB)

(21) Appl. No.: 16/696,804

(22) Filed: Nov. 26, 2019

(51) Int. Cl. H04L 1/00; H04W 72/04; H04W 28/04; H04L 27/26

(52) U.S. Cl. CPC H04L 1/0026; H04L 1/0003; H04W 72/0453; H04L 2027/0067; H04L 1/0015; H04L 27/2686; H04W 28/04

(57) ABSTRACT

Methods, systems, and devices for tampering detection in phase based ranging are described.

A device may engage in two-tone phase based ranging. For example, the device may transmit a composite signal that includes a first carrier at a first frequency and a second carrier at a second frequency. The device may receive a third carrier at the first frequency and measure its phase. The device may determine a phase sum associated with the first frequency based on the measured phase of the third carrier and a measured phase of the first carrier. The device may compare the phase sum with a reference value and determine whether tampering with the phase based ranging has occurred based on the comparison.

### BACKGROUND

The following relates generally to wireless communications, and more specifically to tampering detection in phase based ranging.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets.

In some cases, a wireless device may be configured with a security mechanism that conditions access to a restricted area based on the proximity of an authorized user's wireless device.

### SUMMARY

The described techniques relate to improved methods, systems, devices, and apparatuses that support tampering detection in phase based ranging. Generally, the described techniques provide for two-tone phase based ranging in which composite signals are transmitted rather than single carriers. For example, for each frequency expected during the two-tone phase based ranging a device may transmit a composite signal that includes an authentic carrier at the expected frequency and a decoy carrier at a random frequency. Upon determining the round-trip phase sums for each expected frequency the device may use the round-trip phase sums to determine an error associated with the two-tone phase based ranging. The value of the error may indicate whether tampering with the two-tone phase based ranging has occurred.

A method of wireless communications at a first wireless device is described. The method may include transmitting a composite signal for phase based ranging, the composite signal including a first carrier at a first frequency and a second carrier at a second frequency, receiving from a second wireless device an indication of a phase of the first carrier at the first frequency, measuring, at the first wireless device, a phase of a third carrier at the first frequency transmitted by the second wireless device, determining a phase sum for the first frequency based on the phase of the first carrier and the phase of the third carrier, and determining a tampering status for the phase based ranging based on a comparison between the phase sum for the first frequency and a reference value, where determining the tampering status is independent of a phase of the second carrier at the second frequency.

An apparatus for wireless communications at a first wireless device is described. The apparatus may include a processor, memory coupled with the processor, and instructions stored in the memory. The instructions may be executable by the processor to cause the apparatus to transmit a composite signal for phase based ranging, the composite signal including a first carrier at a first frequency and a second carrier at a second frequency, receive from a second wireless device an indication of a phase of the first carrier at the first frequency, measure, at the first wireless device, a phase of a third carrier at the first frequency transmitted by the second wireless device, determine a phase sum for the first frequency based on the phase of the first carrier and the phase of the third carrier, and determine a tampering status for the phase based ranging based on a comparison between the phase sum for the first frequency and a reference value, where determining the tampering status is independent of a phase of the second carrier at the second frequency.

Another apparatus for wireless communications at a first wireless device is described. The apparatus may include means for transmitting a composite signal for phase based ranging, the composite signal including a first carrier at a first frequency and a second carrier at a second frequency, receiving from a second wireless device an indication of a phase of the first carrier at the first frequency, measuring, at the first wireless device, a phase of a third carrier at the first frequency transmitted by the second wireless device, determining a phase sum for the first frequency based on the phase of the first carrier and the phase of the third carrier, and determining a tampering status for the phase based ranging based on a comparison between the phase sum for the first frequency and a reference value, where determining the tampering status is independent of a phase of the second carrier at the second frequency.

A non-transitory computer-readable medium storing code for wireless communications at a first wireless device is described. The code may include instructions executable by a processor to transmit a composite signal for phase based ranging, the composite signal including a first carrier at a first frequency and a second carrier at a second frequency, receive from a second wireless device an indication of a phase of the first carrier at the first frequency, measure, at the first wireless device, a phase of a third carrier at the first frequency transmitted by the second wireless device, determine a phase sum for the first frequency based on the phase of the first carrier and the phase of the third carrier, and determine a tampering status for the phase based ranging based on a comparison between the phase sum for the first frequency and a reference value, where determining the tampering status is independent of a phase of the second carrier at the second frequency.

Some examples of the method, apparatuses, and non-transitory computer-readable medium described herein may further include operations, features, means, or instructions for determining, based on the comparison, that an error value associated with the phase sum for the first frequency may be greater than a threshold value, and determining that the tampering status may be positive based on the error value being greater than the threshold value.

In some examples of the method, apparatuses, and non-transitory computer-readable medium described herein, the error value may be determined based on phase based ranging that involves an exchange of a set of signals each including a single carrier at a single frequency.

Some examples of the method, apparatuses, and non-transitory computer-readable medium described herein may further include operations, features, means, or instructions for transmitting a set of composite signals each including two carriers at different frequencies, and determining a set of phase sums for half of the frequencies, where the reference value may be based on the set of phase sums and where the half of the frequencies includes a set of frequencies known to the first and second wireless devices. Some examples of the method, apparatuses, and non-transitory computer-readable medium described herein may further include operations, features, means, or instructions for determining a proximity of the second wireless device based on the set of phase sums, and flagging the proximity as incorrect when the tampering status may be positive.

Some examples of the method, apparatuses, and non-transitory computer-readable medium described herein may further include operations, features, means, or instructions for transmitting, to the second wireless device, control information to that indicates a sequence of frequencies for phase based ranging, where measuring the phase of the third carrier may be based on the first frequency being included in the sequence of frequencies.

Some examples of the method, apparatuses, and non-transitory computer-readable medium described herein may further include operations, features, means, or instructions for selecting the second frequency based on the first frequency, where the second frequency may be offset from the first frequency by a threshold frequency.

Some examples of the method, apparatuses, and non-transitory computer-readable medium described herein may further include operations, features, means, or instructions for identifying a period of time during which the third carrier at the first frequency may be expected to be received, and measuring the phase of the third carrier based on the third carrier being received during the identified period of time.

In some examples of the method, apparatuses, and non-transitory computer-readable medium described herein, the period of time occurs within a threshold amount of time before or after transmission of the composite signal.

In some examples of the method, apparatuses, and non-transitory computer-readable medium described herein, receiving the indication of the phase of the first carrier at the first frequency may include operations, features, means, or instructions for receiving the indication in a message from the second wireless device.

In some examples of the method, apparatuses, and non-transitory computer-readable medium described herein, receiving the indication of the phase of the first carrier at the first frequency may include operations, features, means, or instructions for receiving the third carrier at the first frequency, where the phase of the third carrier indicates the phase of the first carrier at the first frequency.

### BRIEF DESCRIPTION OF THE DRAWINGS

FIG. 1 illustrates an example of a system for wireless communications that supports tampering detection in phase based ranging in accordance with aspects of the present disclosure.

FIG. 2 illustrates an example of a wireless communications that supports tampering detection in phase based ranging in accordance with aspects of the present disclosure.

FIGS. 3 and 4 illustrate examples of scatter plots in accordance with aspects of the present disclosure.

FIGS. 5 and 6 illustrate examples of process flows that support tampering detection in phase based ranging in accordance with aspects of the present disclosure.

FIGS. 7 and 8 show block diagrams of devices that support tampering detection in phase based ranging in accordance with aspects of the present disclosure.

FIG. 9 shows a block diagram of a communications manager that supports tampering detection in phase based ranging in accordance with aspects of the present disclosure.

FIG. 10 shows a diagram of a system including a device that supports tampering detection in phase based ranging in accordance with aspects of the present disclosure.

FIG. 11 shows a flowchart illustrating methods that support tampering detection in phase based ranging in accordance with aspects of the present disclosure.

### DETAILED DESCRIPTION

A wireless device may use one or more techniques to determine the proximity of another device. For example, a wireless device may use phase based ranging (PBR) to determine the proximity of another device so that the wireless device can act appropriately when the other device get close. In some cases, the wireless device may lift one or more restrictions protecting an area when the device of an authorized user comes within a threshold distance of the wireless device. Phase based ranging relies on phase measurements of carriers exchanged between the wireless device attempting proximity detection and the device that is the target of the proximity detection. For example, carriers at various frequencies may be exchanged between the two devices, and the phases for the carriers may be used to determine the proximity of the target device.

In some cases, a third-party device may intercept the carriers from the devices and alter the phases so that the distance between detecting device and the target device appears smaller than it actually is. For example the third-party device may receive the carriers transmitted by the two wireless devices, apply suitable phase changes, and retransmit the carriers at a higher power than the authentic carriers. Because the phases of the carriers have been altered, the device performing proximity detection may erroneously determine that the target device is within a threshold distance and act accordingly (e.g., lift security mechanisms that prevent access to a restricted area).

By transmitting a decoy carrier along with the authentic carrier for each frequency used in the phase based ranging, a wireless may detect when a third-party is attempting to tamper with phase based ranging. The decoy carrier and authentic carrier may be at different frequencies and may be included in a composite signal. Because the third-party device is only able to replicate one of the carriers in the composite signal, only half of the phases used to detect proximity will be altered, which allows the detecting device to determine that a tampering attempt has occurred.

Aspects of the disclosure are initially described in the context of a wireless communications system. Additional features of the disclosure are illustrated and described with reference to scatter plots and process flows. Aspects of the disclosure are further illustrated by and described with reference to apparatus diagrams, system diagrams, and flowcharts that relate to tampering detection in phase based ranging.

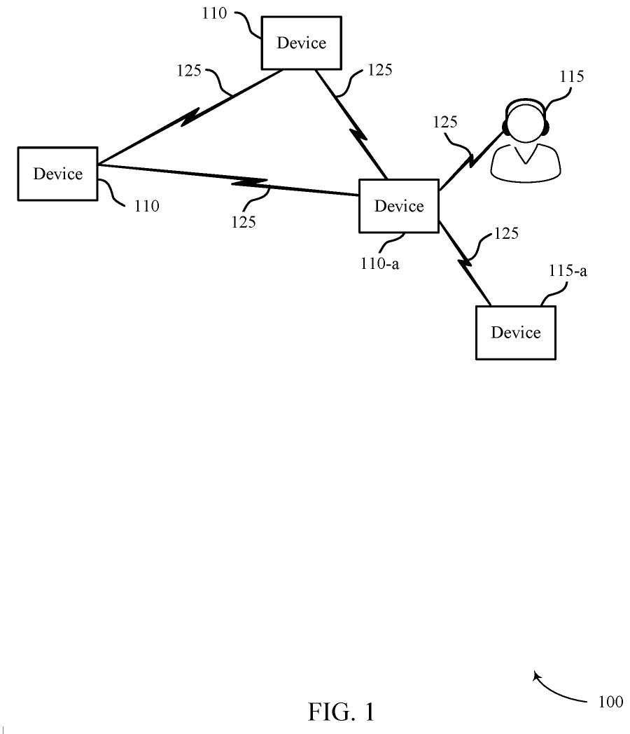

FIG. 1 illustrates an example of a wireless communications system 100 that supports tampering detection in phase based ranging in accordance with aspects of the present disclosure. In some examples, the wireless communications system 100 may include or refer to a wireless personal area network (PAN) or a wireless local area network (WLAN) (e.g., a Wi-Fi network), but the techniques described herein are not limited to these or any other wireless communications networks. The wireless communications system 100 may include devices 110 (e.g., which may be referred to as source devices, master devices, etc.) and paired devices 115 (e.g., which may be referred to as sink devices, slave devices, etc.) implementing wireless communications (e.g., Wi-Fi communications, Bluetooth communications, and the like). Devices 110 may include cell phones, user equipment (UEs), wireless stations (STAs), mobile stations, personal digital assistant (PDAs), other handheld devices, netbooks, notebook computers, tablet computers, laptops, or some other suitable terminology. Paired devices 115 may include Bluetooth-enabled devices capable of pairing with other Bluetooth-enabled devices (e.g., such as devices 110).

Wireless communications system 100 may be organized using a master-slave relationship. In some examples, a device 110 may generally refer to a master device, and a paired device 115 may refer to a slave device in the wireless communications system 100. As such, in some examples, a device may be referred to as either a device 110 or a paired device 115 based on the configuration of the device. That is, designation of a device as either a device 110 or a paired device 115 may not necessarily indicate a distinction in device capability, but rather may refer to or indicate roles held by the device in the wireless communications system 100. Generally, device 110 may refer to a wireless communication device capable of wirelessly exchanging data signals with another device (e.g., a paired device 115), and paired device 115 may refer to a device operating in a slave role, or to a short-range wireless communication device capable of exchanging data signals with the device 110 (e.g., using Bluetooth communication protocols).

Regardless of the communication protocol in use, a connection link 125 may be established between two devices (e.g., between a device 110 and a paired device 115) so that communications and services can be provided. For example, content and control signaling may be exchanged between a device 110 and a paired device 115 via connection link 125. In some examples, the control signaling may facilitate one or more proximity detection techniques that allow one device (e.g., device 110-a) to determine the distance to another device (e.g., device 115-a).

One proximity detection technique employed by device 110-a may be phase based ranging in which the round-trip phases of a sequence of carriers are used as a basis for determining proximity. As discussed in more detail below, the round-trip phases may be determined by exchanging the carriers between the device 110-a and the device 115-a. But in some cases, a third-party device may intercept the carriers from the device 110-a (and/or from device 115-a), manipulate the phases, and repeat them at a higher power so that the device 110-a determines that device 115-a is closer than it actually is. In such cases, the third-party device may be referred to as a man-in-the-middle (MITM) device and its attempt to interfere with (e.g., manipulate) the phase based ranging may be referred to as tampering. When device 110-a uses proximity as a basis for granting access to a restricted area (e.g., to a phone, a laptop, a home, a garage, a car, etc.), tampering may cause device 110-a to grant unauthorized users access to the restricted area.

According to the techniques described herein, a device 110 may detect tampering by transmitting a decoy carrier along with an authentic carrier during phase base ranging. The decoy carrier and the authentic carrier may be at different frequencies and may be included in a composite signal. Because the MITM device is only capable of manipulating the phase of one carrier at a time, only about half of the carriers received at the device 110 will have manipulated phases which allows the device 110 to detect the attempted tampering as discussed in greater detail below.

Although described in the context of Bluetooth, the techniques described herein may be implemented by a device in any type of communications network or independent of a communications network altogether.

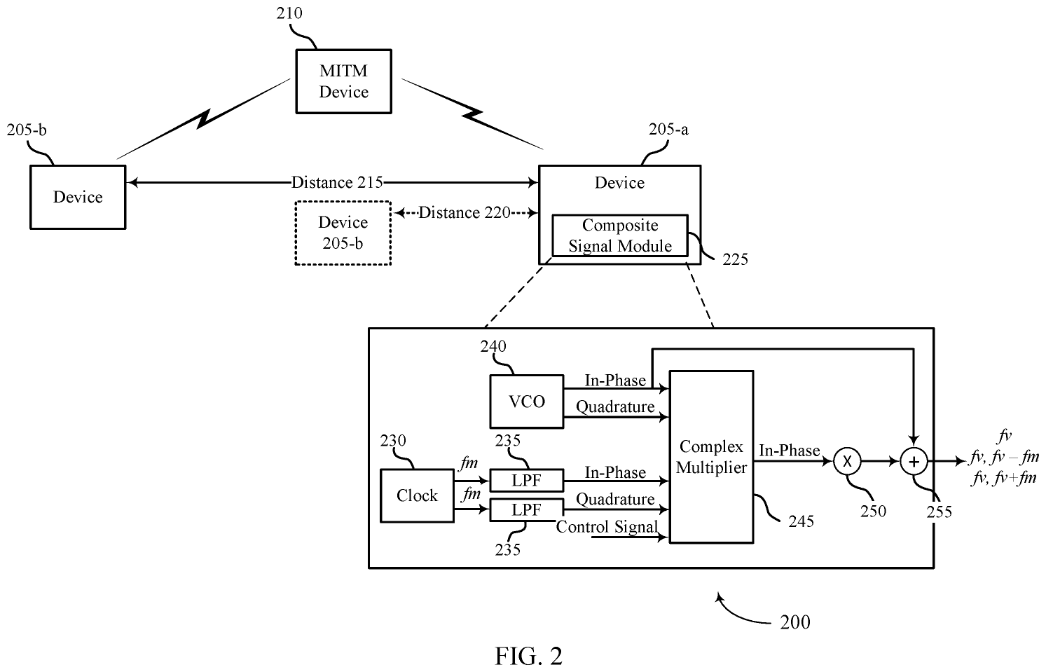

FIG. 2 illustrates an example of a wireless communications system 200 that supports tampering detection in phase based ranging in accordance with aspects of the present disclosure. In some examples, wireless communications system 200 may implement aspects of wireless communication system 100. For example, wireless communications system 200 may include device 205-a and device 205-b, which may be examples of a device 110 and/or device 115 as described with reference to FIG. 1. In some examples, device 205-a is a master device and device 205-b is a slave device but the present disclosure is not limited to devices operating in these respective roles. Device 205-a may use phase base ranging to determine the proximity of device 205-b. In some cases, device 205-a may grant access to a restricted area based on the detected proximity of device 205-b with respect to device 205-a.

Device 205-a may implement phase based ranging by exchanging carriers with device 205-b. A carrier (or “tone”) may be wireless signal that is transmitted over a wireless medium over a relatively narrow frequency band centered about a particular frequency f. Device 205-a may transmit a sequence of carriers, one at a time, to device 205-b and receive the same sequence of carriers, one at a time, from device 205-b. Each carrier may be transmitted at a unique frequency within a respective window of time agreed upon and known a priori by the devices 205. After exchanging carriers with device 205-b, device 205-a may determine the proximity of device 205-b based on the round-trip phase associated with each frequency of the carriers.

The round-trip phase may refer to a combination of the phase of a carrier at frequency f measured at device 205-a and the phase of a corresponding carrier at frequency f measured at device 205-b (and reported to device 205-a). Put another way, the round-trip phase may be calculated based on two phase measurements: a first phase measurement obtained at device 205-b from acquisition of a carrier transmitted by device 205-a and second phase measurement obtained at device 205-a from acquisition of a carrier transmitted by device 20-5-b. The carriers may be at substantially the same frequency and the measurements by the devices 205 may occur within a relatively short amount of time of each other (e.g., within a threshold amount of time on the order of microseconds or milliseconds) to allow cancellation of unknown phase offsets in receivers and transmitters of the devices 205-a. The round-trip phase may also be referred to herein as a phase sum or sum of phases.

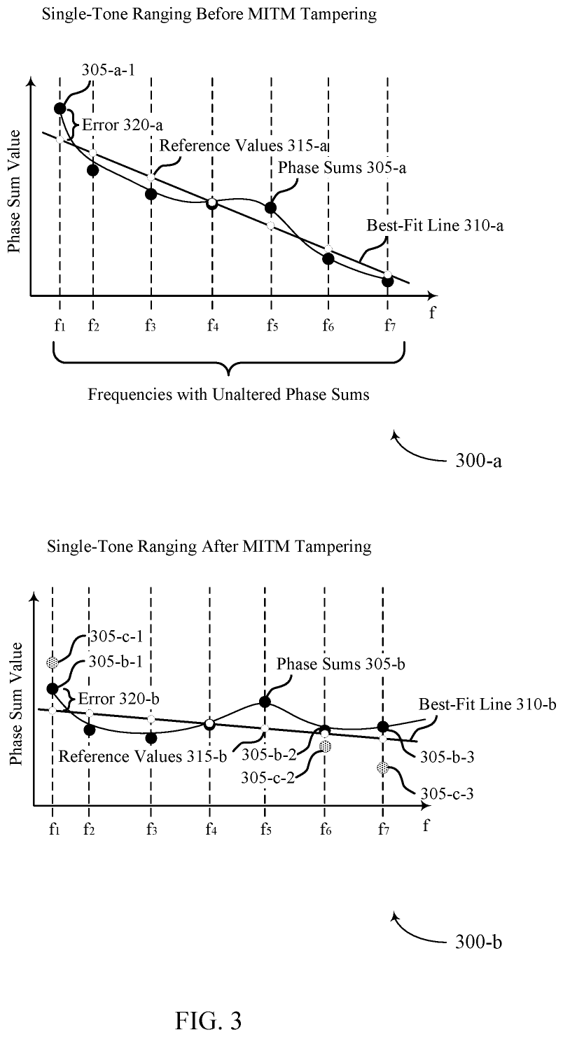

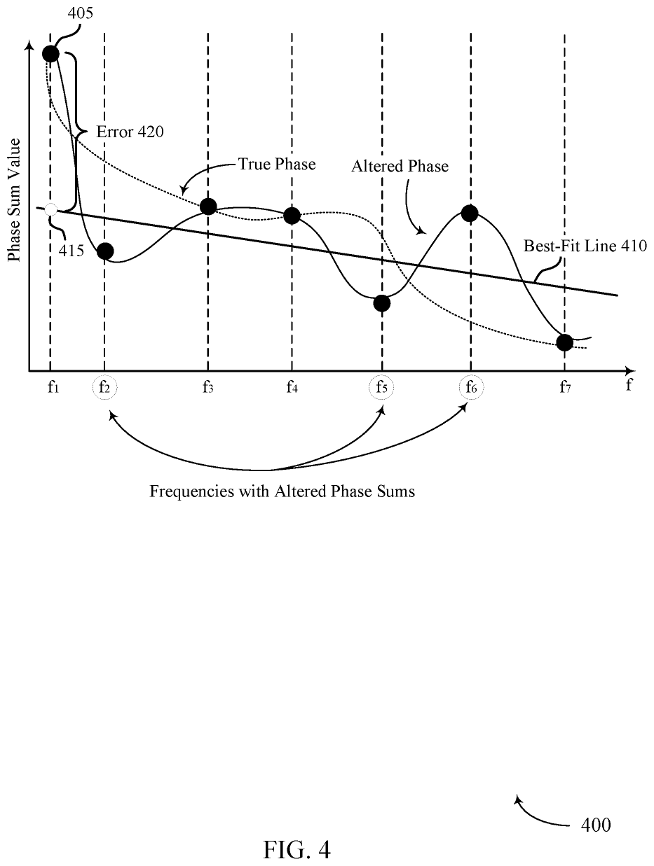

After determining the round-trip phase for each frequency involved in the phase based ranging, device 205-a may determine the proximity of device 205-a based on the relationship between the round-trip phases. For example, device 205-a determines that device 205-b is at distance 215 from device 205-a based on the spread of the round-trip phases as described with greater detail with reference to FIGS. 3 and 4. Thus, device 205-a may detect the proximity of device 205-b using single-tone phase based ranging in which device 205-a transmits a single carrier at a single frequency per window of time.

But in some cases, a third-party device such as MITM device 210 may tamper with the phase based ranging between device 205-a and device 205-b. For example, MITM device 210 may receive carriers from device 205-a and alter the phases of the carriers before transmitting them at a higher power to device 205-b. The MITM device 210 may alter the phases so that the round trip phases for the carrier indicate that device 205-b is closer to device 205-a than it actually is. For example, the altered phases may make it appear as though device 205-b is at distance 220 from device 205-a. Accordingly, device 205-a may remove access restrictions protecting an area, which may allow an unauthorized user to access the area. For example, device 205-a may unlock a door, electronic device, vehicle, etc. based on the erroneous determination that device 205-a is at distance 220.

According to the techniques described herein, device 205-a may detect when a third-party device is tampering with phase based ranging by concurrently transmitting two carriers at different frequencies. For example, device 205-a may transmit a composite signal that includes a first carrier at first frequency f1 and a second carrier at a second frequency f2. Such a technique may be referred to herein as two-tone or dual-tone phase based ranging. A device that employs two-tone phase base ranging may detect tampering by comparing the measured round-trip phases with expected round-trip phases. Because the MITM device is only able to alter the phases of one carrier at a time, only half of the phases will be altered, leading to a large variance between measured and expected round-trip phases.

To implement two-tone phase based ranging, device 205-a may include one or more components that enable device 205-a to concurrently transmit two carriers at two different frequencies. For example, device 205-a may include a composite signal module 225. Composite signal module 225 may include clock component 230, low pass filters 235, voltage-controlled oscillator (VCO) 240, and complex multiplier 245. Composite signal module 225 may also include components configured to amplify a signal at 350 and combine signals at 255.

The clock component 230 may be coupled with low pass filters 235 and may be configured to generate a clock signal at frequency fm. The low pass filters 235 may receive the signal output by the clock component 230 and filter out high frequencies so that the signal is converted from a square wave to a sinusoidal wave with in-phase and quadrature components. This sinusoidal wave may be referred to as a first phasor. The VCO 240 may be configured to generate a second phasor with frequency fv that also has in-phase and quadrature components. The first and second phasors may be multiplied by complex multiplier 245 to create an offset carrier that has a frequency of fv+fm when the control signal is high (e.g., equal to one) and fv−fm when the control signal is low (e.g., equal to zero). The in-phase component of the offset carrier may be amplified at 250 before being combined with the in-phase component of the first phasor at 255. Thus, the output of composite signal module 225 may be composite signal that includes first carrier at frequency fv and a second carrier at frequency fv+fm or frequency fv−fm.

In an alternative implementation of two-tone phase based ranging, the transmitter device comprises two VCOs that can be configured to create the two separate and concurrent carrier signals: one with the authentic frequency and the other with the decoy frequency. The two carrier signals are suitably combined to construct a composite two-tone signal that is transmitted.

In a further digital-based implementation, one or more decoy carrier signals can be constructed along with the authentic carrier signal to form a larger composite signal. For example, the larger composite signal could be constructed digitally by summing multiple suitably oversampled complex exponential waveforms with suitable frequency offsets and passed through a wide-band modulator and mixer to obtain a suitable radio frequency (RF) waveform.

FIG. 3 illustrates examples of scatter plots 300 in accordance with aspects of the present disclosure. Each scatter plot 300 may be a plot of phase sums 305 versus frequency, where the frequency is that of the carrier corresponding to the phase sum. Scatter plot 300-a illustrates phase sums 305-a before tampering by a MITM device and scatter plot 300-b illustrates phase sums 305-b after tampering by a MITM device. In some cases, tampering by a MITM device may also be referred to as a MITM attack or MITM interference.

The phase sums 305 that are shown in black may represent the round-trip phases associated with a sequence of frequencies used in single-tone phase base ranging. The phase sums 305-a may be represent unaltered phase sums for single-tone phase based ranging and the phase sums 305-b may represent altered phased sums for single-tone phase based ranging. Thus, the phase sums 305-a show the correct distance gradient before tampering, whereas phase sums 305-b show a reduced gradient due to tampering. The phase sums 305 that are shown in grey may represent the unaltered round-trip phases associated with two-tone phase based ranging. The points at the frequencies have the correct phase because the MITM attacked the decoy tone instead of the authentic carrier (e.g., the MITM incorrectly guessed authentic carrier). The black points at other frequencies represent the times when the MITM attacked the authentic frequencies (e.g. the MITM correctly guessed the authentic carrier). Although seven frequencies (e.g., f1 through f7) are shown any quantity of frequencies may be used.

As discussed above, a device may determine a phase sum by adding the measured phases of two carriers transmitted at the same frequency by two devices. For example, phase sum 305-a-1 may be calculated by adding the measured phase of a first carrier at frequency f1 and the measured phase of a second carrier at frequency f1. The first carrier may be transmitted by a first device (e.g., a master device) and the second carrier may be transmitted by a second device (e.g., a slave device). Both carriers may be transmitted within a period of time agreed upon by the devices and the period of time may be different from other periods of time during which the devices transmit carriers at the other frequencies. For example, the carriers at the first frequency f1 may be transmitted during a first period of time and the carriers at the second frequency f2 may be transmitted during a second period of time different than the first period of time.

Upon determining the phase sum for each frequency, the master device may plot the phase sums versus frequency to create scatter plot 300-a. The master device may then determine a best-fit line 310-a that best represents the data on scatter plot 300-a. The gradient (e.g., slope) of the best-fit line 310-a may be proportional to the distance between the slave device and the master device. For example, a larger gradient (e.g., a steeper incline) may represent a greater distance than a smaller gradient. Thus, the master device may determine the proximity of the slave device based on the gradient of the best-fit line. Put another way, the master device may determine the proximity of the slave device based on the relationship between the phase sums. In some cases, the master device may calculate the gradient of the best-fit line 310-a by calculating the derivative of the best-fit line 310-a.

The best-fit line 310-a may be associated with a quantity of reference values 315-a, which may also be referred to as expected values or expected phase sums. A reference value 315-a may be the value of the best-fit line at each frequency f. The difference between the phase sum for each frequency and the reference value for that frequency may be referred to as the error to the best-fit line. For example, the difference between phase sum 305-a-1 and the reference value for frequency f1 may be error 320-a. In some cases, the errors for two or more frequencies may be added to generate an error value that represents the reliability of the phase based ranging. A higher error value may mean the phase based ranging is unreliable and a low error value may mean that the phase based ranging is reliable.

Scatter plot 300-b may illustrate phase sums 305-b after a MITM device has tampered with phase based ranging. Because the MITM device has altered the phases of the carriers received by one of the participating devices, the phase sums 305-b may be more closely grouped than the phase sums 305-a. Accordingly, the best-fit line 310-b may have a smaller gradient than best-fit line 310-a, which may cause the master device to attribute a distance to the slave device that is smaller than the actual distance. That is, the ability of the MITM device to alter the phase of each frequency in the sequence of frequencies results in a gradient that is reduced relative to a tampering-free gradient. Further the error value associated with the single-tone phase based ranging may be relatively small because the phase for each frequency is adjusted. For example, the error 320-b for each frequency may be small because the phase sums 305-b upon which the best-fit line 310-b is based are all altered by the MITM device. Thus, a master device using single-tone phase based ranging may determine that the single-tone phase based ranging is reliable even though tampering has occurred. As described above, the error to the best-fit line 310-b for a frequency f may be the difference between the phase sum for that frequency and the reference value 315-b for that frequency.

According to the techniques described herein, a master device may implement two-tone phase based ranging to detect tampering. For example, the master device may transmit a composite signal for each frequency in the sequence of frequencies involved in the phase based ranging. The composite signal for a given frequency may include a first carrier at the frequency and a second frequency at a different frequency. The first carrier at the first frequency may be referred to as the authentic carrier because that carrier is the carrier for which the master device will determine a phase sum. The second carrier at the second frequency may be referred to as the decoy carrier because the master device may not determine a phase sum for that carrier.

As an example, when the master device is scheduled to transmit a carrier at frequency f1, the master device may instead transmit a composite signal that includes a carrier at frequency f1 and a carrier at frequency f1±f_{offset}, where f_{offset} is an offset frequency. Thus, the master device may transmit a composite signal that includes an authentic carrier at f1 and a decoy carrier at frequency other than f1. The master device may transmit similar composite signals for the other frequencies in the sequence of frequencies. The frequency offset for the decoy signal in each composite signal may be the same as f_{offset} or different from f_{offset}. Because the decoy carrier is solely for the benefit of the MITM device, the slave device may be unaware of the decoy carrier. Thus, two-tone phase based ranging may be implemented by a single device without the knowledge of the other device. In other cases, the slave device may also implement two-tone phase based ranging in which the slave device also transmits composite signals as described herein.

A MITM device is only able to intercept and repeat one carrier at a time, so the MTIM device that receives the composite signal must select one of the carriers in the composite signal to replicate. Because the likelihood of the MITM selecting the authentic carrier is only fifty percent, the MITM will only be able to alter the phase of about half of the authentic carriers. This means that the phase sums calculated for these authentic carriers will be altered while the phase sums for the other authentic carriers are unaltered. Such inconsistency in phase sum alteration may alert the master device that tampering has been attempted.

As an example, consider the scenario in which the MITM device replicates the decoy carriers in the composite signals for frequencies f1, f6, and f7. Accordingly, the phase sums for these frequencies may be calculated using the unaltered authentic carriers, resulting in phase sums 305-c-1, 305-c-2, and 305-c-3. These phase sums 305-c may deviate from the reference values for f1, f6, and f7 more than the phase sums 305-b-1, 305-b-2, and 305-b-3 (which represent single-tone phase sums that have been altered by the MITM device). So, the error value for the two-tone phase based ranging may be larger than the error value for the single-tone phase based ranging even though both are subject to tampering.

Accordingly, the master device may determine whether tampering has occurred by comparing the error value for two-tone phase base ranging with the error value for single-tone phase based ranging. If the error value for two-tone ranging is greater than the error value for single-tone phase based ranging, the master device may determine that tampering has occurred. Otherwise, the master device may determine that tampering has not occurred. Alternatively, the master device may determine whether tampering has occurred by comparing the error value for two-tone phase based ranging with a threshold error value. If the error value is greater than the threshold error value, the master device may determine that tampering has occurred. If the error value is less than the threshold error value, the master device may determine that tampering has not occurred.

FIG. 4 illustrates an example of a scatter plot 400 that supports tampering detection in phase based ranging in accordance with aspects of the present disclosure. Scatter plot 400 may illustrate phase sums 405 after a MITM device tampers with two-tone phase based ranging. Scatter plot 400 may be a plot of phase sums 405 versus frequency and the frequencies f1 through f7 may be included in a sequence of frequencies agreed upon by master device and slave device. Although seven frequencies (e.g., f1 through f7) are shown any quantity of frequencies may be used. For each frequency f1 through f7, a composite signal may be transmitted that includes an authentic carrier at the given frequency (e.g., f1) and a decoy carrier at different frequency (e.g., f1+f_{offset}).

The phase sum 405 for a frequency may be determined by adding a first phase measurement of a first carrier transmitted by the master device and a second phase measurement of a second carrier transmitted by the slave device. The first carrier and the second carrier may be at the same frequency and the first carrier may be included in a composite signal (e.g., the first carrier may be an authentic carrier that is simultaneously transmitted with a decoy carrier). In some cases, the second carrier may also be included in a composite signal. The first phase may be the phase of the first carrier measured by the slave device and the second phase may be the phase of second carrier measured by the master device. In some cases, the first phase may be reported to the master device in a message. In other cases, the first phase may be indicated to the master device by adjusting the phase of the second carrier that is transmitted to the master device.

Because the authentic carrier for each frequency is transmitted along with a decoy carrier, a MITM device attempting to tamper with the two-tone phase based ranging will need to guess which carrier is authentic. The MITM device has a fifty percent chance of correctly guessing the authentic carrier, so the MITM device will only be able alter the phase of about half of the authentic carriers. This means that the other half of authentic carriers will be unaltered, resulting in large variances between phase sums and a poorly fit best-fit line.

As an example, consider scatter plot 400. In this example, the MITM device may correctly guess the authentic carrier for frequencies f2, f5, and f6. However, the MITM device may incorrectly guess the authentic carrier for frequencies f1, f3, f4, and f7. Thus, the phase sums for frequencies f2, f5, and f7 may be altered by the MITM device and the phase sums for frequencies f1, f3, f4, and f7 may be unaltered. Accordingly, and the errors to the best-fit line 410 may be large. For example, the difference between phase sum 405 and reference value 415 may be large relative to the difference that would arise if single-tone phase based ranging was used. So, a device that uses two-tone phase based ranging may detect tampering by comparing the phase sums 405 and reference values 415. The comparison may indicate errors 420, which may be compared to one or more threshold errors to detect tampering. Alternatively, the errors 420 may be combined to create an error value for the phase based ranging that can be compared to a threshold error value.

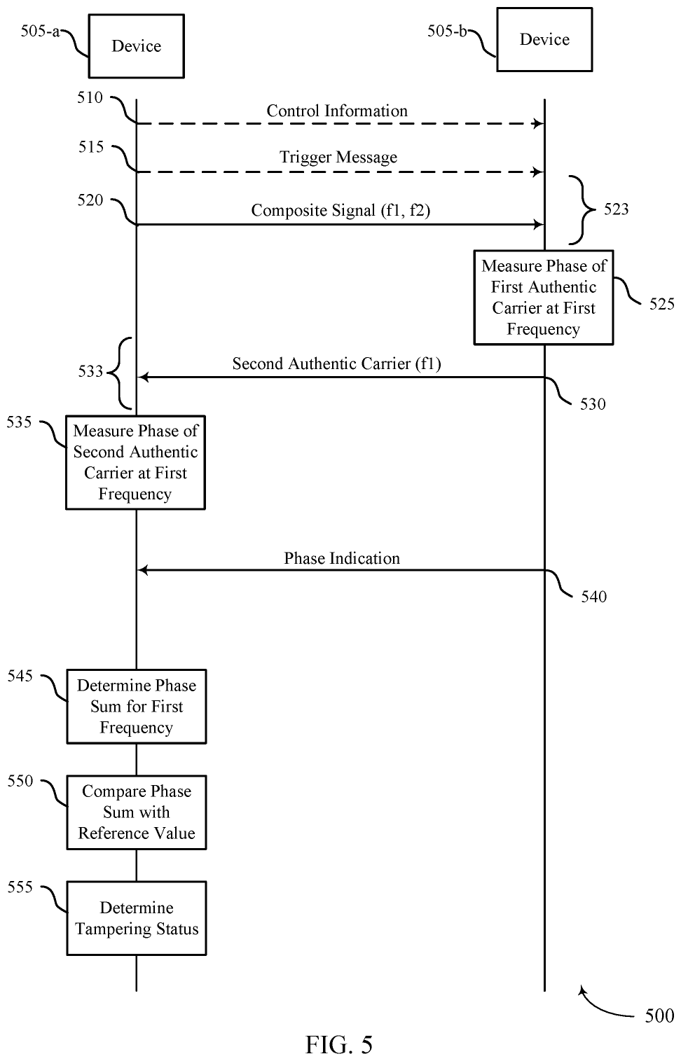

FIG. 5 illustrates an example of a process flow 500 that supports tampering detection in phase based ranging in accordance with aspects of the present disclosure. In some examples, process flow 500 may implement aspects of wireless communications systems 100 and 200. For example, process flow 500 may include device 505-a device 505-b, which may be examples of a device 110, device 115, or device 205 described with reference to FIGS. 1 and 2. In some cases, device 505-a is a master device and device 505-b is a slave device but the present disclosure is not limited to devices operating in these respective roles.

In the following description of the process flow 500, the operations between device 505-a and device 505-b may occur in a different order than the exemplary order shown, or the operations performed by the devices may be performed in different orders or at different times. Certain operations may also be left out of the process flow 500, or other operations may be added to the process flow 500.

At 510, device 505-a may transmit control information to device 505-b. The control information may include an indication of a sequence of frequencies that device 505-b is to use for phase based ranging. The sequence of frequencies may be a set of frequencies that are to be transmitted in a particular order. So, in some examples the control information may indicate the set of frequencies as well as the order in which the frequencies are to be transmitted. In other example, the control information may indicate information that allows device 505-b to generate the sequence of frequencies. For example, the control information may include one or more values that serve as a basis for randomly selecting the frequencies in the sequence. Thus, the sequence of frequencies may be chosen randomly using a known random number sequence that is based on a secret shared between device 505-a and device 505-b.

In some examples, device 505-a and device 505-b may negotiate the sequence of frequencies (e.g., device 505-a and device 505-b may exchange control signaling to arrive at an agreed-upon sequence of frequencies). Alternatively, the sequence of frequencies may be preconfigured at the devices 505. Regardless of how the devices establish the sequence of frequencies, the sequence of frequencies may be known to both device 505-a and device 505-b prior to initiating phase based ranging. In some examples, the control information may include timing information, such as an indication of when to initiate phase based ranging. For instance, the control information may indicate a period of time that the devices 505 are to exchange carriers at a first frequency in the sequence of frequencies.

At 515, device 505-a may transmit a trigger message to device 505-b based on determining that the the period of time approaches for exchanging carriers at the first frequency. The trigger message may synchronize the devices 505 and may indicate that device 505-b is expected to transmit a carrier at the first frequency within a threshold amount of time relative to receipt of the trigger message. In some cases, a trigger message may be referred to as a request message and may include a request for transmission of the carrier at the first frequency during an indicated period of time.

At 520, device 505-a may transmit a composite signal for a duration of time (e.g., tens of microseconds). The composite signal may include a first authentic carrier at the first frequency (e.g., f1) and a first decoy carrier at a second frequency (e.g., f2). The first frequency may be included in the agreed-upon sequence of frequencies and may be the frequency expected by device 505-b during period of time 523 and the second frequency may be randomly selected. Although in some cases the second frequency f2 may be coincidentally included in the sequence of frequencies, device 505-b will ignore the decoy carrier because the second frequency f2 is not expected by device 505-b during period of time 523 (e.g., because the second frequency occurs later in the order of the sequence of frequencies). The second frequency f2 may be selected using any type of technique (e.g., randomly, based on a known number sequence, based on the first frequency, etc.), however, device 505-a may mitigate interference between the two carriers by selecting the second frequency so that it is at least a threshold frequency band (e.g., several MHz) away from the first frequency.

At 525, device 505-b may measure the phase of the first authentic carrier received from device 505-a. For example, device 505-b may tune its radio to the first frequency based on the expectation that the first authentic carrier will be received during period of time 523. Thus, device 505-b may measure the phase of the first authentic carrier based on the sequence of frequencies and the period of time 523.

At 530, device 505-b may transmit a second authentic carrier at the first frequency (e.g., f1) based on the control information received at 510 and/or the trigger message received at 515. At 535, device 505-b may measure the phase of the second authentic carrier based on the control information. For example, device 505-b may tune its radio to the first frequency based on the expectation that the second authentic carrier will be received during period of time 533. The period of time 533 may be pre-arranged (e.g., by the control information or the trigger message) or the period of time 533 may be based on the timing of the composite signal. For example, the period of time 533 may be a window of time that is relative to transmission of the composite signal. In some cases, device 505-b may transmit the second authentic carrier along with a decoy carrier in a composite signal. In such cases, device 505-a may measure the phase of the authentic carrier but not the phase of the decoy carrier (e.g., because the radio of device 505-a is tuned to the first frequency f1 instead of the second frequency f2).

At 540, device 505-b may transmit an indication of the measured phase of the first authentic carrier. In some cases, the indication of the measured phase may be explicit. For example, the measured phase may be indicated by one or more bits in a message transmitted to device 505-a. In other cases, the indication of the measured phase may be implicit. For example, the measured phase may be indicated by the phase of the second authentic carrier. For instance, device 505-b may modify its local oscillator so that the phase of the second authentic carrier accounts for the measured phase. In such cases, the phase measured by device 505-a at 535 may represent the phase sum.

At 545, device 505-a may determine a phase sum for the first frequency. The phase sum may represent a combination of the measured phase of the first authentic carrier and the measured phase of the second authentic carrier. In some cases (e.g., when the measured phase for the first authentic carrier is explicitly indicated), device 505-a may determine the phase sum via digital addition. In other cases, (e.g., when the measured phase for the first authentic carrier is implicitly indicated), device 505-a may determine the phase sum by analog addition.

At 550, device 505-a may compare the phase sum for the first frequency with a reference value. The reference value may be a value that is expected for the phase sum for the first frequency and may be based on the phase sums for other frequencies (e.g., the reference value may be a point on the best-fit line, which is based on phase sums for the sequence of frequencies). At 555, device 505-a may determine the tampering status for the phase based ranging based on the comparison of the phase sum for the first frequency with the refence value for the first frequency. For example, device 505-a may determine that tampering has occurred if the difference between the phase sum and the reference value is greater than a threshold value. The threshold value may be associated with tampering or the threshold value may be associated with single-tone phase based ranging. Because the decoy carrier included in the composite signal does not contribute to proximity detection, the tampering status may be determined independent of the phase of the decoy carrier.

Although described with reference to a single phase sum, it should be understood that tampering detection may involve the computation of additional phase sums for other frequencies in the sequence of frequencies. And although process flow 500 only depicts one exchange of carriers, it should be appreciated that two-tone phase based ranging may involve the exchange of multiple carriers as described herein. For example, the processes between 515 and 550, inclusively, may be replicated for additional authentic frequencies that are included in the sequence of frequencies. Thus, multiple phase sums for multiple authentic carries may be determined and used as a basis for the tampering detection.

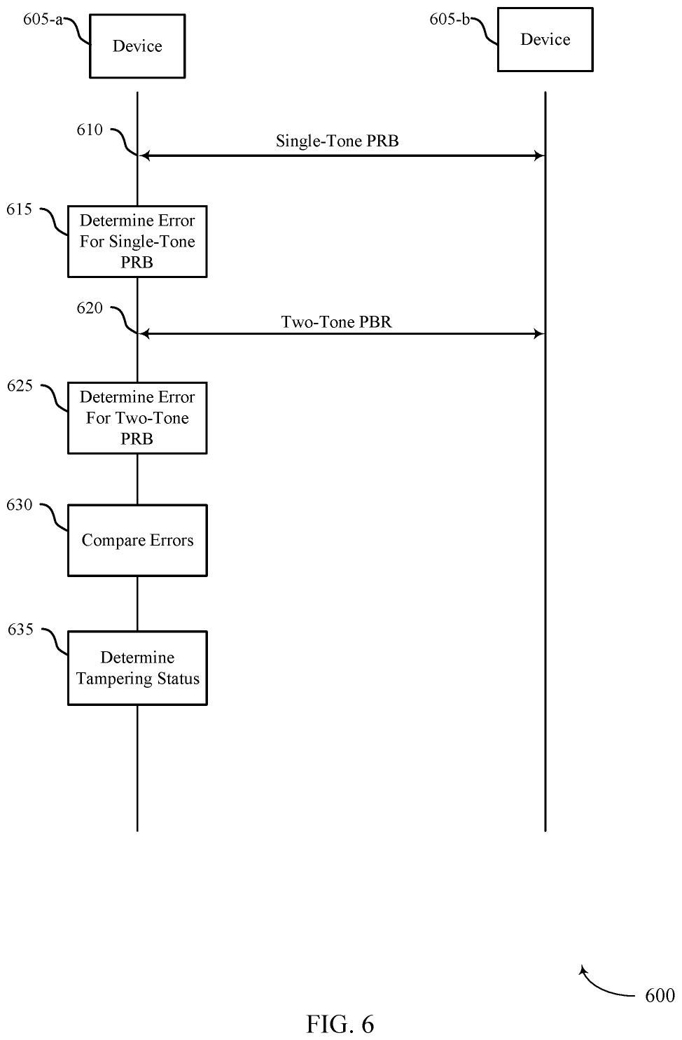

FIG. 6 illustrates an example of a process flow 600 that supports tampering detection in phase based ranging in accordance with aspects of the present disclosure. In some examples, process flow 600 may implement aspects of wireless communications systems 100 and 200. For example, process flow 500 may include device 605-a and device 605-b, which may be examples of a device 110, device 115, device 205, or device 505 described with reference to FIGS. 1, 2, and 5. In some cases, device 605-a is a master device and device 605-b is a slave device but the present disclosure is not limited to devices operating in these respective roles.

In the following description of the process flow 600, the operations between device 605-a and device 605-b may occur in a different order than the exemplary order shown, or the operations performed by the devices may be performed in different orders or at different times. Certain operations may also be left out of the process flow 600, or other operations may be added to the process flow 600.

At 610, device 605-a and device 605-b may participate in single-tone phase based ranging as described herein. At 615, device 605-a may determine one or more errors associated with the single-tone phase based ranging. For example, device 605-a may determine one or more errors 320 by comparing a measured phase sum with an expected phase sum (which may also be referred to as a reference value). In some examples, device 605-a may determine an error value associated with the single-tone phase based ranging based on multiple errors 320. The error value may represent the accuracy or reliability of the proximity determined by the single-tone phase based ranging.

At 620, device 605-a and device 605-b may participate in two-tone phase based ranging as described herein. At 625, device 605-a may determine one or more errors associated with the two-tone phase based ranging. For example, device 605-a may determine one or more errors 420 by comparing a measured phase sum with an expected phase sum (which may also be referred to as a reference value). In some examples, device 605-a may determine an error value associated with the two-tone phase based ranging based on multiple errors 420. The error value may represent the accuracy or reliability of the proximity determined by the two-tone phase based ranging.

At 630, device 605-a may compare the error(s) associated with the single-tone phase based ranging to the error(s) associated with the two-tone phase based ranging. For example, device 605-a may compare an error 320 for a first frequency with the error 420 for the first frequency. Or device 605-a may compare the error value associated with the single-tone phase based ranging with the error value associated with the two-tone phase based ranging.

At 635, device 605-a may determine whether tampering has occurred based on the comparison of the errors at 630. If the error associated with two-tone phase based ranging is less than or equal to the error associated with single-tone phase based ranging, the device 605-a may determine that tampering has not occurred. If the error associated with two-tone phase based ranging is greater than the error associated with single-tone phase based ranging, the device 605-a may determine that tampering has occurred. Upon determining that tampering has occurred, device 605-a may treat the proximity detected using phase-based ranging (single-tone or dual tone) as erroneous. Accordingly, device 605-a may refrain from acting on the detected proximity. For example, device 605-a may maintain one or more proximity-based security mechanisms protecting a restricted area even though the phase based ranging indicates that the proximity condition for lifting the mechanisms has been satisfied.

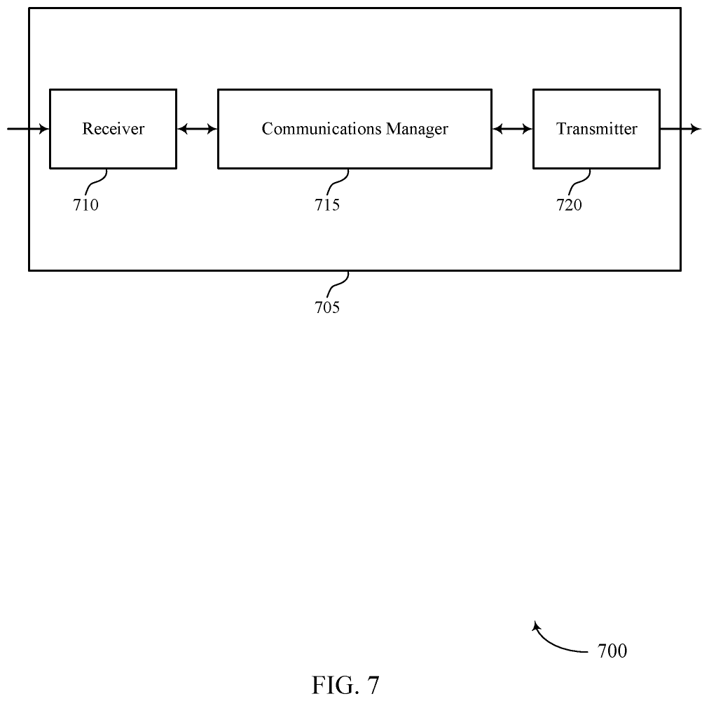

FIG. 7 shows a block diagram 700 of a device 705 that supports tampering detection in phase based ranging in accordance with aspects of the present disclosure. The device 705 may be an example of aspects of a device 110 or device 115 as described herein. The device 705 may include a receiver 710, a communications manager 715, and a transmitter 720. The device 705 may also include a processor. Each of these components may be in communication with one another (e.g., via one or more buses).

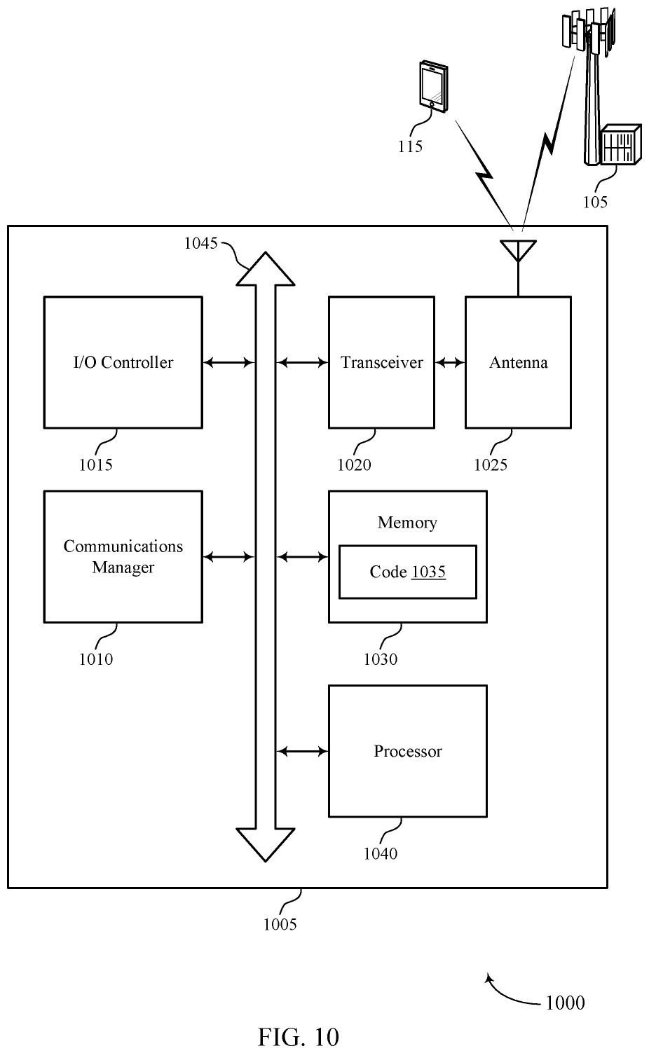

The receiver 710 may receive information such as packets, user data, or control information associated with various information channels (e.g., control channels, data channels, and information related to tampering detection in phase based ranging, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may transmit a composite signal for phase based ranging. The composite signal may include a first carrier (e.g., a first authentic carrier) at a first frequency and a second carrier (e.g., a decoy carrier) at a second frequency. The communications manager 715 may receive from a second wireless device an indication of a phase of the first carrier at the first frequency. The communications manager 715 may measure, at the first wireless device, a phase of a third carrier (e.g., a second authentic carrier) at the first frequency transmitted by the second wireless device. The communications manager 715 may determine a phase sum for the first frequency based on the phase of the first carrier and the phase of the third carrier and determine a tampering status for the phase based ranging based on a comparison between the phase sum for the first frequency and a reference value. In some examples, the tampering status is determined independent of a phase of the second carrier at the second frequency. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG.10. The transmitter 720 may utilize a single antenna or a set of antennas.

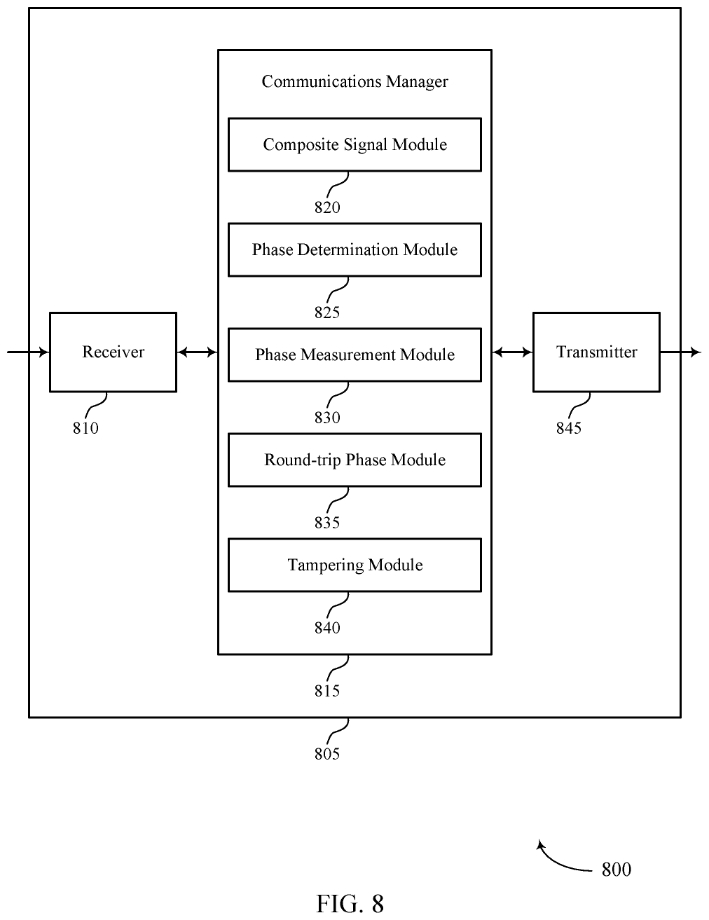

FIG. 8 shows a block diagram 800 of a device 805 that supports tampering detection in phase based ranging in accordance with aspects of the present disclosure. The device 805 may be an example of aspects of a device 110, device 115, or device 705 as described herein. The device 805 may include a receiver 810, a communications manager 815, and a transmitter 845. The device 805 may also include a processor. Each of these components may be in communication with one another (e.g., via one or more buses).

The receiver 810 may receive information such as packets, user data, or control information associated with various information channels (e.g., control channels, data channels, and information related to tampering detection in phase based ranging, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a composite signal module 820, a phase determination module 825, a phase measurement module 830, a round-trip phase module 835, and a tampering module 840. The communications manager 815 may be an example of aspects of the communications manager 1010 described herein.

The composite signal module 820 may transmit a composite signal for phase based ranging, the composite signal including a first carrier at a first frequency and a second carrier at a second frequency. The phase determination module 825 may receive from a second wireless device an indication of a phase of the first carrier at the first frequency. The phase measurement module 830 may measure, at the first wireless device, a phase of a third carrier at the first frequency transmitted by the second wireless device. The round-trip phase module 835 may determine a phase sum for the first frequency based on the phase of the first carrier and the phase of the third carrier. The tampering module 840 may determine a tampering status for the phase based ranging based on a comparison between the phase sum for the first frequency and a reference value, where determining the tampering status is independent of a phase of the second carrier at the second frequency.

The transmitter 845 may transmit signals generated by other components of the device 805. In some examples, the transmitter 845 may be collocated with a receiver 810 in a transceiver module. For example, the transmitter 845 may be an example of aspects of the transceiver 1020 described with reference to FIG. 10. The transmitter 845 may utilize a single antenna or a set of antennas.

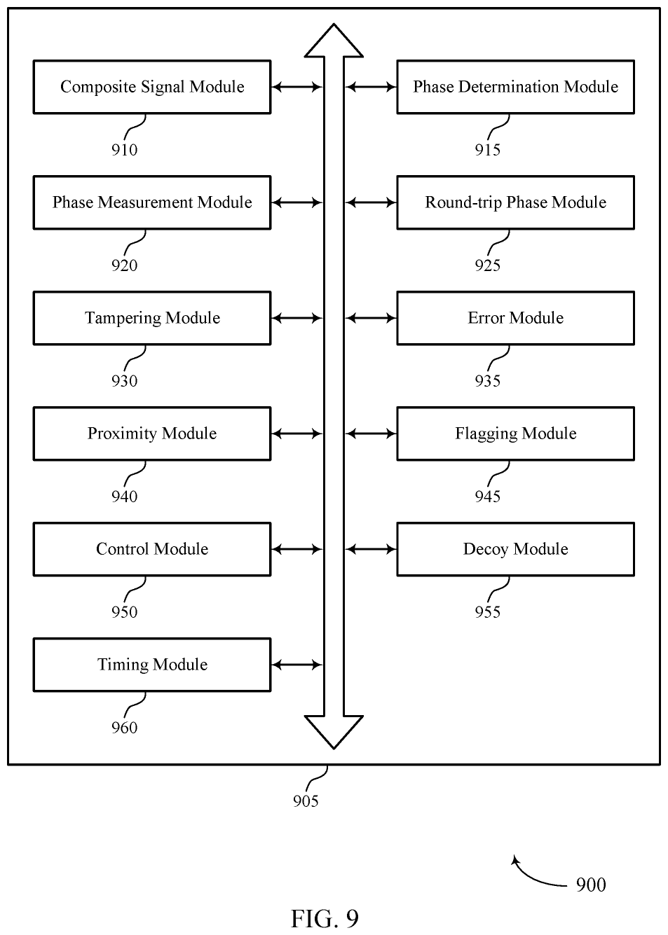

FIG. 9 shows a block diagram 900 of a communications manager 905 that supports tampering detection in phase based ranging in accordance with aspects of the present disclosure. The communications manager 905 may be an example of aspects of a communications manager 715, a communications manager 815, or a communications manager 1010 described herein. The communications manager 905 may include a composite signal module 910, a phase determination module 915, a phase measurement module 920, a round-trip phase module 925, a tampering module 930, an error module 935, a proximity module 940, a flagging module 945, a control module 950, a decoy module 955, and a timing module 960. Each of these modules may communicate, directly or indirectly, with one another (e.g., via one or more buses).

The composite signal module 910 may transmit a composite signal for phase based ranging. The composite signal may include a first carrier at a first frequency and a second carrier at a second frequency. In some examples, the composite signal module 910 may transmit a set of composite signals each including two carriers at different frequencies. For example, the composite signal module 910 may transmit a composite signal for each frequency included in the sequence of frequencies established for two-tone phase based ranging. The composite signals may be transmitted at different times according to an order of the sequence of frequencies.

The phase determination module 915 may receive from a second wireless device an indication of a phase of the first carrier at the first frequency. In some examples, the phase determination module 915 may receive the indication in a message from the second wireless device. In some examples, the phase determination module 915 may receive a third carrier at the first frequency, where the phase of the third carrier indicates the phase of the first carrier at the first frequency.

The phase measurement module 920 may measure, at the first wireless device, a phase of the third carrier at the first frequency transmitted by the second wireless device. The round-trip phase module 925 may determine a phase sum for the first frequency based on the phase of the first carrier and the phase of the third carrier. When the composite signal module 910 transmits a set of composite signals each including two carriers at different frequencies, the round-trip phase module 925 may determine a set of phase sums for half of the frequencies associated with the set of composite signals, where the reference value is based on the set of phase sums.

The tampering module 930 may determine a tampering status for the phase based ranging based on a comparison between the phase sum for the first frequency and a reference value. The tampering module 930 may determine the tampering status is independent of a phase of the second carrier (e.g., the decoy carrier) at the second frequency.

The error module 935 may determine, based on the comparison, that an error value associated with the phase sum for the first frequency is greater than a threshold value. In some examples, the tampering module 930 may determine that the tampering status is positive based on the error value being greater than the threshold value. In some cases, the error value is determined based on phase based ranging that involves an exchange of a set of signals each including a single carrier at a single frequency (e.g., based on single-tone phase based ranging).

The proximity module 940 may determine a proximity of the second wireless device based on the phase sum for the first frequency. The flagging module 945 may flag the proximity as incorrect when the tampering status is positive.

The control module 950 may transmit, to the second wireless device, control information to that indicates a sequence of frequencies for phase based ranging. In such examples, the phase measurement module 920 may measure the phase of the third carrier based on the first frequency being included in the sequence of frequencies.

The decoy module 955 may select the second frequency based on the first frequency, where the second frequency is offset from the first frequency by a threshold frequency.

The timing module 960 may identify a period of time during which the third carrier at the first frequency is expected to be received. In some cases, the period of time occurs within a threshold amount of time before or after transmission of the composite signal. In some examples, the phase measurement module 920 may measure the phase of the third carrier based on the third carrier being received during the identified period of time.

FIG. 10 shows a diagram of a system 1000 including a device 1005 that supports tampering detection in phase based ranging in accordance with aspects of the present disclosure. The device 1005 may be an example of or include the components of a device 110, device 115, device 505, device 605, device 705, or a device 805 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may transmit a composite signal for phase based ranging, the composite signal including a first carrier at a first frequency and a second carrier at a second frequency, receive from a second wireless device an indication of a phase of the first carrier at the first frequency, measure, at the first wireless device, a phase of a third carrier at the first frequency transmitted by the second wireless device, determine a phase sum for the first frequency based on the phase of the first carrier and the phase of the third carrier, and determine a tampering status for the phase based ranging based on a comparison between the phase sum for the first frequency and a reference value, where determining the tampering status is independent of a phase of the second carrier at the second frequency.

The I/O controller 1015 may manage input and output signals for the device 10. The I/O controller 1015 may also manage peripherals not integrated into the device Error! Reference source not found.05. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include RAM and ROM. The memory 1030 may store computer-readable, computer-executable code 1035 including instructions that, when executed, cause the processor to perform various functions described herein. In some cases, the memory 1030 may contain, among other things, a BIOS which may control basic hardware or software operation such as the interaction with peripheral components or devices.

The processor 1040 may include an intelligent hardware device, (e.g., a general-purpose processor, a digital signal processor (DSP), a central processing unit (CPU), a microcontroller, an ASIC, a field-programmable gate array (FPGA), a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting tampering detection in phase based ranging).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

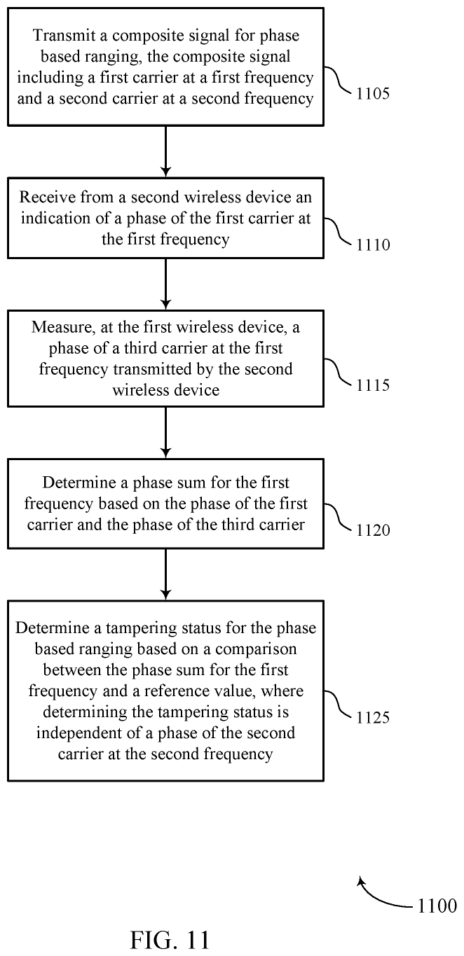

FIG. 11 shows a flowchart illustrating a method 1100 that supports tampering detection in phase based ranging in accordance with aspects of the present disclosure. The operations of method 1100 may be implemented by a first wireless device or its components as described herein. For example, the operations of method 1100 may be performed by a communications manager as described with reference to FIGS. 7 through 10. In some examples, a first wireless device may execute a set of instructions to control the functional elements of the first wireless device to perform the functions described below. Additionally or alternatively, a first wireless device may perform aspects of the functions described below using special-purpose hardware.

At 1105, the method may include transmitting a composite signal for phase based ranging, the composite signal including a first carrier at a first frequency and a second carrier at a second frequency. The operations of 1105 may be performed according to the methods described herein. In some examples, aspects of the operations of 1105 may be performed by a composite signal module as described with reference to FIGS. 2, 8, and 9.

At 1110, the method may include receiving from a second wireless device an indication of a phase of the first carrier at the first frequency. The operations of 1110 may be performed according to the methods described herein. In some examples, aspects of the operations of 1110 may be performed by a phase determination module as described with reference to FIGS. 7 and 8.

At 1115, the method may include measuring, at the first wireless device, a phase of a third carrier at the first frequency transmitted by the second wireless device. The operations of 1115 may be performed according to the methods described herein. In some examples, aspects of the operations of 1115 may be performed by a phase measurement module as described with reference to FIGS. 7 and 8.

At 1120, the method may include determining a phase sum for the first frequency based on the phase of the first carrier and the phase of the third carrier. The operations of 1120 may be performed according to the methods described herein. In some examples, aspects of the operations of 1120 may be performed by a round-trip phase module as described with reference to FIGS. 7 and 8.

At 1125, the method may include determining a tampering status for the phase based ranging based on a comparison between the phase sum for the first frequency and a reference value, where determining the tampering status is independent of a phase of the second carrier at the second frequency. The operations of 1125 may be performed according to the methods described herein. In some examples, aspects of the operations of 1125 may be performed by a tampering module as described with reference to FIGS. 7 and 8.

What is claimed is:

1. A method for wireless communications at a first wireless device, comprising:
transmitting a composite signal for phase based ranging, the composite signal comprising a first carrier at a first frequency and a second carrier at a second frequency;
receiving from a second wireless device an indication of a phase of the first carrier at the first frequency;
measuring, at the first wireless device, a phase of a third carrier at the first frequency transmitted by the second wireless device;
determining a phase sum for the first frequency based at least in part on the phase of the first carrier and the phase of the third carrier; and
determining a tampering status for the phase based ranging based at least in part on a comparison between the phase sum for the first frequency and a reference value, wherein determining the tampering status is independent of a phase of the second carrier at the second frequency.

2. The method of claim 1, further comprising:
determining, based at least in part on the comparison, that an error value associated with the phase sum for the first frequency is greater than a threshold value; and
determining that the tampering status is positive based at least in part on the error value being greater than the threshold value.

3. The method of claim 2, wherein the error value is determined based at least in part on phase based ranging that involves an exchange of a plurality of signals each comprising a single carrier at a single frequency.

4. The method of claim 1, further comprising:
transmitting a plurality of composite signals each comprising two carriers at different frequencies; and
determining a plurality of phase sums for half of the frequencies associated with the plurality of composite signals, wherein the reference value is based at least in part on the plurality of phase sums and wherein the half of the frequencies comprises a set of frequencies known to the first and second wireless devices.

5. The method of claim 4, further comprising:
determining a proximity of the second wireless device based at least in part on the plurality of phase sums; and
flagging the proximity as incorrect when the tampering status is positive.

6. The method of claim 1, further comprising:
transmitting, to the second wireless device, control information to that indicates a sequence of frequencies for phase based ranging, wherein measuring the phase of the third carrier is based at least in part on the first frequency being included in the sequence of frequencies.

7. The method of claim 6, further comprising:
selecting the second frequency based at least in part on the first frequency, wherein the second frequency is offset from the first frequency by a threshold frequency.

8. The method of claim 1, further comprising:
identifying a period of time during which the third carrier at the first frequency is expected to be received; and
measuring the phase of the third carrier based at least in part on the third carrier being received during the identified period of time.

9. The method of claim 8, wherein the period of time occurs within a threshold amount of time before or after transmission of the composite signal.

10. The method of claim 1, wherein receiving the indication of the phase of the first carrier at the first frequency comprises:
receiving the indication in a message from the second wireless device.

11. The method of claim 1, wherein receiving the indication of the phase of the first carrier at the first frequency comprises:
receiving the third carrier at the first frequency, wherein the phase of the third carrier indicates the phase of the first carrier at the first frequency.

12. An apparatus for wireless communication at a first wireless device, comprising:
a processor,
memory coupled with the processor; and
instructions stored in the memory and executable by the processor to cause the apparatus to:
transmit a composite signal for phase based ranging, the composite signal comprising a first carrier at a first frequency and a second carrier at a second frequency;
receive from a second wireless device an indication of a phase of the first carrier at the first frequency;
measure, at the first wireless device, a phase of a third carrier at the first frequency transmitted by the second wireless device;
determine a phase sum for the first frequency based at least in part on the phase of the first carrier and the phase of the third carrier; and
determine a tampering status for the phase based ranging based at least in part on a comparison between the phase sum for the first frequency and a reference value, wherein determining the tampering status is independent of a phase of the second carrier at the second frequency.

13. The apparatus of claim 12, wherein the instructions are executable by the processor to cause the apparatus to:
determine, based at least in part on the comparison, that an error value associated with the phase sum for the first frequency is greater than a threshold value; and
determine that the tampering status is positive based at least in part on the error value being greater than the threshold value.

14. The apparatus of claim 13, wherein the error value is determined based at least in part on phase based ranging that involves an exchange of a plurality of signals each comprising a single carrier at a single frequency.

15. The apparatus of claim 12, wherein the instructions are executable by the processor to cause the apparatus to:
transmit a plurality of composite signals each comprising two carriers at different frequencies; and
determine a plurality of phase sums for half of the frequencies, wherein the reference value is based at least in part on the plurality of phase sums and wherein the half of the frequencies comprises a set of frequencies known to the first and second wireless devices.

16. The apparatus of claim 15, wherein the instructions are executable by the processor to cause the apparatus to:
determine a proximity of the second wireless device based at least in part on the plurality of phase sums; and
flag the proximity as incorrect when the tampering status is positive.

17. The apparatus of claim 12, wherein the instructions are executable by the processor to cause the apparatus to:
transmit, to the second wireless device, control information to that indicates a sequence of frequencies for phase based ranging, wherein measuring the phase of the third carrier is based at least in part on the first frequency being included in the sequence of frequencies.

18. The apparatus of claim 17, wherein the instructions are executable by the processor to cause the apparatus to:
select the second frequency based at least in part on the first frequency, wherein the second frequency is offset from the first frequency by a threshold frequency.

19. The apparatus of claim 12, wherein the instructions are executable by the processor to cause the apparatus to:
identify a period of time during which the third carrier at the first frequency is expected to be received; and
measure the phase of the third carrier based at least in part on the third carrier being received during the identified period of time.

20. An apparatus for wireless communications at a first wireless device, comprising:
means for transmitting a composite signal for phase based ranging, the composite signal comprising a first carrier at a first frequency and a second carrier at a second frequency;
means for receiving from a second wireless device an indication of a phase of the first carrier at the first frequency;
means for measuring, at the first wireless device, a phase of a third carrier at the first frequency transmitted by the second wireless device;
means for determining a phase sum for the first frequency based at least in part on the phase of the first carrier and the phase of the third carrier; and
means for determining a tampering status for the phase based ranging based at least in part on a comparison between the phase sum for the first frequency and a reference value, wherein determining the tampering status is independent of a phase of the second carrier at the second frequency.
